(19) United States
(12) Patent Application Publication
(10) Pub. No.: US 2011/0191318 A1
(43) Pub. Date: Aug. 4, 2011

(54) COMMUNITY SEARCH SYSTEM WITH RELATIONAL RANKING

(76) Inventors: David Gilbey, London (GB); Michael Clowes, London (GB)

(21) Appl. No.: 12/993,041

(22) PCT Filed: May 15, 2009
(86) PCT No.: PCT/GB2009/001221

§ 371 Date: Feb. 22, 2011

(30) Foreign Application Priority Data
May 16, 2008 (EP) 08156377.7

(51) Int. Cl. G06F 17/30

(52) U.S. Cl. 707/706; 707/723; 707/E17.108

(57) ABSTRACT

In the present invention, there is provided a computer system (10) for retrieving published content from a social network of users in which each user has connections to one or more other users, and in which the degree of separation between users within the social network is defined as the number of connections required to connect two given users. The system (10) comprises a database (14) for storing a plurality of content assets published by users, each content asset being indexed against one or more users in the network, a network user map (13) stored in memory which, for each user, identifies degrees of separation between that user and other users in the social network, an application interface (12) for receiving an online search request from a first user, a search engine (15) having a system index for identifying one or more stored content assets that match the search request; and a processor for filtering the matching content assets to identify content assets indexed against users within the first user's network user map and generate search results ranked in dependence on the degree of separation between the first user and the user or users associated with the one or more matching content assets.

The present invention provides a content searching service allowing users to search for and retrieve stored content according to their personal relationships with other users who are part of their social network. Unlike conventional methods, the present invention does not provide the same content to every user regardless of context, but rather presents the content according to their relationship with the user(s) associated with (indexed against) that content.

### FIELD OF THE INVENTION

The present invention relates to online search services for content published by users in a digital social network.

### BACKGROUND TO THE INVENTION

Conventionally, a number of reference tools have existed to enable people to identify the information they need. Directories, dictionaries and encyclopaedias have come to be replaced by electronic technologies, in particular online search technology.

Existing search engines index content on the internet and allow users to obtain answers to questions asked in the form of search queries input into a search box. These search engines have adapted to manage the ever larger volumes of information stored on the world wide web (WWW).

Notwithstanding the growth of online search engines, users still often resort to alternative forms of information management. For example, classified advertisements, both on and offline, and even listings on physical, local notice boards, remain popular ways for individuals to both source and offer goods and services.

As a result of the large amount of information available in the modern world, both classified advertisement systems and search engines face the problem of delivering information to users that is most relevant to each user's particular needs and circumstances.

Using existing search engine technology known in the prior art, a typical query entered into a search engine will return more results than a reasonable person could ever sort through or digest. For example, a search for ‘holiday’ entered into two of the four most popular existing search engines returned between 146 million and 377 million results. A query for ‘used car’ returns between 52 million and 74 million results.

Of these, typically only the first 10 entries generated will be displayed on the first page of results, with just 4 or as few as 2 of these results visible ‘above the fold’ (that is, in the viewable area available to the user) on the most commonly used PC screen.

Search engines are therefore required to order the results requested in such a manner as to ensure that the most useful or desired results appear first. However, regardless of what algorithm or complex weighting system is adopted, the search engine will return the same results regardless of the individual user's needs.

Similarly, classified advertisement systems may offer simple search facilities, in addition to ordering results by relevant characteristics such as price, to allow users to navigate the available goods. However, existing classified listings are again not optimised for the individual user and inherently provide the same results regardless of need. As for conventional search engines, currently available classified advertisement systems will return the same results whether the user is a 21 year old male or a 50 year old woman, regardless of their level of knowledge or their circumstances.

Classified advertisements also suffer from a lack of trust, particularly online. Users are wary about the reliability of those involved in the process. Although online schemes have attempted to address this by incorporating various rating systems to allow users to rate buyers and sellers, these schemes are unsatisfactory in that they have not convinced users that they have sufficient information to be able to judge the reliability of a buyer or seller involved in a given transaction.

Digital social networks are very popular on the internet, with almost ten percent of all internet time spent on social networking sites such as Facebook®, LinkedIn®, Twitter® and MySpace®. These sites allow users to share content and information within communities of online users and provide a variety of ways for users to interact with each other. Users typically make connections with other users in order to receive content or updates on their ‘friends’ activities. However, existing social networks are primarily communication systems.

Ineffective scalability has crippled many growing social network based sites and therefore it is important to ensure the system architecture is specifically designed to provide the performance and scalability critical to success.

### SUMMARY OF THE INVENTION

According to a first aspect of the present invention, there is provided a computer implemented method of retrieving published content from a social network of users in which each user has connections to one or more other users, and in which the degree of separation between users within the social network is defined as the number of connections required to connect two given users, the method comprising the steps of:
storing a plurality of content assets published by users in a storage system, each content asset being indexed against one or more users in the network;
maintaining a network user map which, for each user, identifies degrees of separation between that user and other users in the social network;
receiving an online search request from a first user;
searching the stored content assets to identify one or more content assets that match the search request;
filtering the matching content assets to identify content assets indexed against users within the first user's network user map; and,
generating search results for matching content assets which are ranked in dependence on the degree of separation between the first user and the user or users associated with the one or more matching content assets.

According to a second aspect of the present invention, there is provided a computer system for retrieving published content from a social network of users in which each user has connections to one or more other users, and in which the degree of separation between users within the social network is defined as the number of connections required to connect two given users, the system comprising:
a database for storing a plurality of content assets published by users, each content asset being indexed against one or more users in the network;
a network user map stored in memory which, for each user, identifies degrees of separation between that user and other users in the social network;
an application interface for receiving an online search request from a first user;
a search engine having a system index for identifying one or more stored content assets that match the search request; and,
a processor for filtering the matching content assets to identify content assets indexed against users within the first user's network user map and generate search results ranked in dependence on the degree of separation between the first user and the user or users associated with the one or more matching content assets.

The present invention provides a content searching service allowing users to search for and retrieve stored content according to their personal relationships with other users who are part of their social network. Unlike conventional methods, the present invention does not provide the same content to every user regardless of context, but rather presents the content according to their relationship with the user(s) associated with (indexed against) that content. People are far more willing to trust content derived from those they know and trust already, and the present invention presents this in accordance with this natural impulse. As a result, the information provided by the present invention is of significantly higher value to users than that provided by prior art arrangements.

In addition to searching for stored content assets within the storage system accessible by users, the search engine of the system may also include a web index thereby to facilitate searching of the world wide web (WWW) to identify web content that matches the search request.

Preferably, the content assets are digital content selected from a group including: answers, attachments, categories, classifieds, comments, feedbacks, geocodes, groups, invitations, messages, offers, photo albums, questions, relationships, scrapbook folders, scrapbook items, subscriptions, users and web links. Two or more stored content assets can be linked to create associated content assets which can be retrieved as a single search result.

Preferably, content assets that are indexed by the search engine are stored within polymorphic tables.

Each content asset may have associated viewing permissions and therefore preferably the system first determines whether the first user has permission to view a matching content asset before adding the matching content to the search results.

The connections between users define degrees of separation between them. For example, a first user and a second user who are directly connected are one degree of separation (1-step) apart, while if they are connected via a third party then they are two degrees of separation (2-steps) apart. If two third parties are required to connect the users then they are three degrees of separation (3-steps) apart, and so on. Preferably, the search results indicate the degree of separation. More preferably, the search results identify the one or more users associated with (indexed against) the one or more matching content assets.

Preferably, the stored network user map is dynamically updated when a new 1-step connection is created between a user and another user in the social network. Preferably the network user map is also dynamically updated when an existing 1-step connection is deleted between a user and another user in the social network.

Preferably, the network user map is derived from a stored network file which has a list of all user connections with just one degree of separation (1-step apart).

Preferably, the network user map is created by parsing the network file to identify all connected users with n degrees of separation, where n is greater than or equal to two, and preferably n is equal to 3. The network user map stores all connections between users by degrees of separation. It is stored in volatile memory to ensure that the data is current, the system is scaleable and the performance optimal.

The search results may also be ranked or filtered in dependence on other criteria such as: the date of origin, geographical proximity, or indications of relevance of the content items.

### BRIEF DESCRIPTION OF THE DRAWINGS

A preferred embodiment of the present invention will now be described in detail with reference to the accompanying drawings, in which:

FIG. 1 shows a schematic overview of a communications system incorporating an embodiment of the present invention;

FIG. 2 shows a schematic view of a system architecture in accordance with an embodiment of the present invention;

FIGS. 3a-3d illustrate an exemplary process of creating a network user map in accordance with an embodiment of the present invention;

FIG. 4 illustrates an exemplary process of updating a network user map in accordance with an embodiment of the present invention;

FIG. 5 illustrates an exemplary process of saving a content asset to a user's scrapbook; and,

FIG. 6 illustrates an exemplary sequence of events that occurs when the embodiment is used as classified advertisement service;

### DETAILED DESCRIPTION

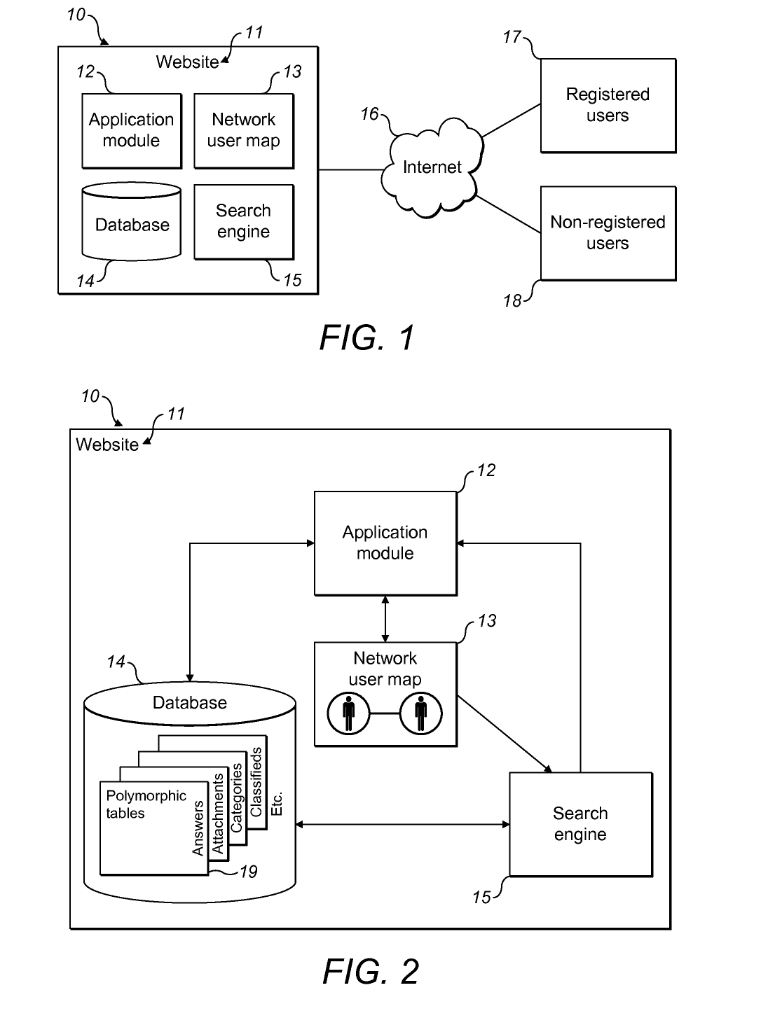

The preferred embodiment of the present invention takes the form of a computer system 10, as shown in FIG. 1, providing a website 11 incorporating a social network of users 17. However, the present invention could equally be incorporated into existing social networks of users. Registered 17 and non-registered users 18 can access the website 11 through the internet 16 and using a conventional web browser or mobile browser, however non-registered users 18 will not be offered full functionality until they register.

The users' web browsers access the system via the application module 12. Content published by registered users 17 of the system 10 is stored within a database 14 which is indexed by a search engine 15, enabling efficient and effective access.

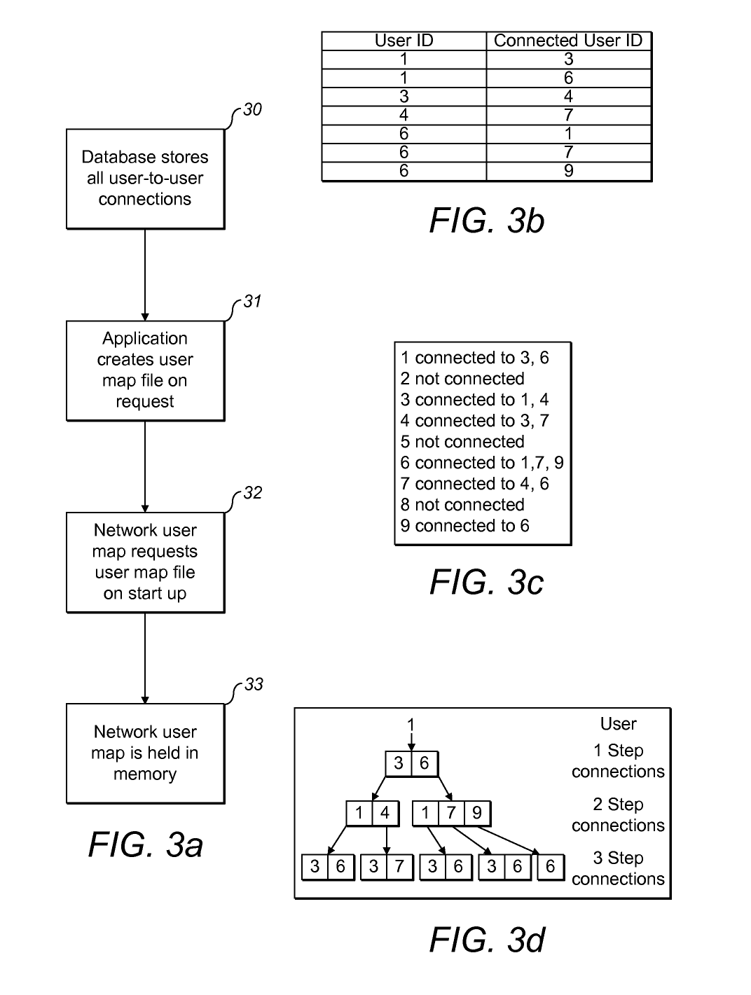

FIG. 2 expands upon the system 10 of FIG. 1, and schematically illustrates the software implementation of a preferred embodiment of the present invention. The system is implemented on two Linux® based servers, in which one server houses the application module 12 and the database 15, and the other server houses the search engine 15 and the network user map 13. Although in this example, the system is implemented using two co-located Linux® based servers, the skilled person would understand that the system could be implemented using a distributed computer system environment in a number of geographical locations using a number of different servers and configurations.

Users of the preferred embodiment of the present invention choose to form connections with other users which are stored in the network user map 13. This provides a number of facilities, only some of which relate directly to the present invention. For example, users may be able to organise social events with, or send messages to, those users with which they have established connections.

The present invention enables users to obtain information from other users with which they have established connections (their ‘1-step’ contacts), users directly connected to their 1-step contacts (their ‘2-step’ contacts), users directly connected to their 2-step contacts (their ‘3-step’ contacts) and so on. The user is therefore able to make a judgement on the value of the retrieved information according to the degree of separation of the source of that information from themselves. Users can dynamically expand or decrease their filter criteria by varying the degrees of separation used when searching. They may also apply other filter criteria such as geographical location.

Users may establish connections by sending a request to people who may or may not be registered users of the system themselves at the time of the request. Typically, this request will take the form of an email asking the other person to connect.

This invitation to connect could take various forms: for example, a simple invitation to connect, or an invitation to connect as a means to answer a specific question, or to help with a specified task.

By connecting to a series of people, each user would build up their own, unique social network of direct (1-step) connections, likely to comprise people they know from various walks of life, including from their work, their geographical neighbourhood, people they know from school or college, or from a social, sport or special interest club.

Given each of their own 1-step connections would also invite or be invited to connect with their own 1-step contacts, the original user would gradually build a wider social network of 1, 2, 3 step contacts and so on. Assuming each user connects with 75 users, they would build a social network of 5,625 2-step contacts, 421,000 3-step, 31 million 4-step, and 2.3 billion 5-step connections.

The user has various options to exploit this network of direct and indirect contacts. For example, a user may ask questions of their direct and indirect network of connections. Such functionality allows users to interact with people they know and with whom they share a sufficient degree of mutual trust for them to be willing and able to ask and answer questions, mimicking real life situations and behaviours.

The application module 12 of the website 11 incorporates messaging and organisational tools to enable users to set up and manage a group. An example would be a sports club wishing to share information and content between the members of the club. The site stores the ‘network’ of relationships, along with the content entered by each member of that group—in this case, all members of the sports club. A user of the system can be an individual or a representative of a group of individuals.

At the time of publishing content to the site, the user is offered the choice to make the content ‘private’, which restricts the visibility of that content to the chosen group of individuals, or to leave the content ‘public’ and available for all.

All of the content published by members of that sports club that is not marked as private is made available to all users of the site (unless the group itself is private).

In this application, published content shall be referred to as individual ‘content assets’ to aid understanding. The content assets can be associated to multiple individuals or groups within the social network in a variety of ways. Users can be associated with the content assets by interacting with it, such as commenting, saving to a scrapbook (described in detail below), making an offer in response to a classified advert or sharing content assets with a connected user. The system 10 also enables users to control their ongoing association with a content asset and have certain controls over how that content asset interacts with other users, for example, visibility, alerts and update subscriptions.

A content asset may take a variety of forms. A primary content asset is original content created by a user. All users can create primary content assets using the functionality provided, for example, classified advertisements for products and services, questions, photo albums, personal and group user profiles, invitations between users and scrapbook folders. These original content assets are automatically indexed by, and thereby associated with, the user who created them. The user who created the content asset has a variety of controls over their association to the original content asset which determines how others can interact with the content and the original creator of the content.

The system 10 enables an individual content asset to be associated with other content assets, known as associated content assets. Users can interact with primary content assets created by themselves or other users, thereby creating further content assets that are associated with the primary content assets. For example, messages and resulting message streams, comments associated with other content assets, offers in response to classified adverts and answers to questions. This collection of content assets is subsequently indexed and made available to other users as a single content asset along with the identity of the creator of the primary content asset and the identities of the creators of the associated content assets.

In addition, the content asset may be a scrapbook item. Any content asset can be saved by any user into their own or their groups' scrapbooks and optionally within scrapbook folders that the user can create. By saving a content asset the user creates a new asset that refers to the content asset being saved. In addition, users can save websites into their scrapbooks that they find by searching the separate web index. Scrapbook items are effectively associated content assets in functional terms. The system indexes all the scrapbook items, scrapbooks and folders that are stored on the server, thereby allowing users to search the collective scrapbooks and folders of all users.

Content assets can also include references to and copies of external documents, including PDFs, images, web URLs and associated thumbnails, audio and video files and a variety of third party documents such as Microsoft Word. These documents are always referenced to a primary or associated asset, such as a classified advert or an answer to a question, a scrapbook asset, photo album or a group profile. Preferably, the search engine 15 can also index the content of external documents.

Over time, the site accrues a rich variety and depth of content as users register, connect with friends and share information through the site.

All data and content assets are stored in a database 14, which is implemented using MySQL®. Content assets that are indexed by the search engine 15 are stored within polymorphic tables 19. These polymorphic tables 19 contain the data to enable users to interact with content and one another through the functionality provided within the application module 12. By storing the data in polymorphic tables 19, content assets of different types can be handled in a common manner by the database 14 and content assets can be associated with other content assets. Each table contains the references and content for a specific class of content. The classes of content can comprise: answers, attachments, categories, classifieds, comments, feedback, geocodes, groups, invitations, messages, offers, photo albums, questions, relationships, scrapbook folders, scrapbook items, subscriptions, users and weblinks.

In the case of a classified advertisement, for example, the content asset would comprise: its ID number and that of its creator user, the category of subject it belongs to (e.g. sports equipment), the owner type (including individual and group), descriptors (including description, price, expiry details etc.), location, comment and offer status and any attachments, together with visibility permissions and alert targets (one or more users who are targeted to receive the advertisement).

Once information has been indexed, users may search for it as required. If stored information (such as a question/answer, classified advert or saved website) matches the query, that piece of content is returned to the user who has initiated the search.

When content assets are presented to a searching user, they are presented once only, with all associated users' information and interactions with the content asset clustered or nested. Typically, the content asset presented to the user includes the title and descriptive information of the returned content. In the case of an external website being returned, the URL and thumbnail graphic of that site would be returned also. Advantageously, information indicating the relationship between the user making the search and the user that is the source of the returned content is also shown. For example, the searching user may be informed that the answer came from someone who is a 2-step contact, and who is a 1-step connection of their sister even though the searching user is not connected to the creator.

Users adding content to the system may ‘target’ it towards specific individuals or groups of users (for example, their 1-step contacts, or members of a particular group). Moreover, search queries may also be targeted in this way. For example, a question could be targeted to all of their 1-step contacts or a specified sub-set of their 1-step contacts, or a classified advert for a child's bicycle could be targeted to those contacts that a user knows has suitably aged children.

Answers given to questions are typically available to be included in the results of any subsequent, relevant question asked by another user. Similarly, comments on a classified advertisement (such as asking the frame size of the bicycle, for example) are also made publicly available. However, users may designate content as private if they would prefer information they add not to be available to others and users can send private messages to the seller. Users may also designate that only certain other users (such as their 1-step contacts) may see any particular content they add.

All user interaction with the system is controlled and enabled by the application module 12, which in this preferred embodiment is implemented using ‘Ruby on Rails’® and comprises multiple functional tools and applications. These include:
communications functionality such as messaging, email, comments and content asset sharing;
content asset creation such as tools to create, publish and maintain classified adverts, questions and photo albums;
user relationship management including the ability to send and receive invitations to connect with other users, search and browse user profiles and create groups of users;
content asset upload such as photo/audio/video file uploads, the ability to attach and index external documents, the search function to search for websites and save links in the system; and,
find, save and share including tools, such as the scrapbook, to save and share any content assets with other users and to apply permissions that control the visibility or identity of content and its creators.

The provision of tools and functionality within the application module 12 allows information to be captured for later searches. Users may make use of the following features to create individual content assets, amongst others:
web-based messaging;
a question and answer facility, allowing a question to be targeted to a given set of users to solicit their opinion, either privately or publicly. The questions and related answers may be stored for other users to access subsequently;
a classifieds implementation, allowing users to offer items for sale/trade or to source items or services;
scrapbooking—the ability to store and group together links to content, whether they be a local item or an external website, as discussed in more detail below;
a web search engine—users can make use of this facility, and then subsequently store the results in their scrapbook or the scrapbook of a group they belong to if they wish; and,
attachments—uploaded documents or pictures that can be attached to questions and classifieds or stored in a scrapbook.

The search engine 15, a third party application, indexes the polymorphic tables 19 in the database 14 and attached documents periodically (at a certain frequency) to ensure acceptable latency for users. For example, the search engine 15 could index the tables 19 every 30 seconds. Any new data, users or content added to the database 14 would then be immediately indexed. This then enables the user to search the index for content assets, according to any combination of application type (e.g. classifieds), content category (e.g. sports equipment) and keyword or search term, in order to retrieve all of the related content in the database from the full range of available content assets.

In addition, the search engine 15 may comprise an index of internet websites that allows users to implement a standard web search but then allows them to easily save those websites to their personal scrapbook and to share those saved websites with any connected users. The personal scrapbook is indexed by the search engine along with the other content assets. A scrapbook item is associated with the user who saves it.

Results from a content asset search are preferably displayed with the associated user's name and their relationship to the user asking the question attached to the content asset, allowing the user to make a trust/value judgement on the returned content asset.

To quickly and easily indicate to the user the degree of separation between them and another user, a colour coding system is used. In this example, the relationship proximities are represented by red for 1-step, orange for 2-step, green for 3-step and blue for not connected.

The results returned to the user after a content asset search, are presented in dependence on the relationship between the searching user and those users with whom the content is associated. Indeed, in particular examples, the searching user may filter the results according to the degree of separation (1-step contacts, 2-step contacts, and so on) between themselves and the originator of the content.

The polymorphic table 19 entries are also parsed to determine all users associated with a matched content asset. The results and users may also be weighted at this time to select the most relevant asset to present when there is more than one relevant asset. For example, if a 1-step user has commented on the same asset as a 2-step user, the system will determine which result to present in the collapsed results list based on a set of weightings including date, relationship proximity, user status and geographical proximity.

Associated search results are then collapsed according to this weighting, in order to deliver only one result for any one classified advertisement to the searching user. For instance, a users comment on a classified advertisement will be collapsed alongside the original classified title and the users photo and orange badge indicating that they are in the 2-step network appended to it. The results will also reference the original creator of the classified advertisement along with the number of offers and comments that exist.

In order to filter the results, the search engine 15 retrieves from the network user map 13 all user connections for the searching user, whenever a search occurs.

The network user map 13 stores all connections between users by degrees of separation. It is stored in volatile memory, in this case Random Access Memory (RAM) to ensure that the data is current, the system is scaleable and the performance optimal. In this example, it is limited to 3-step relationships only.

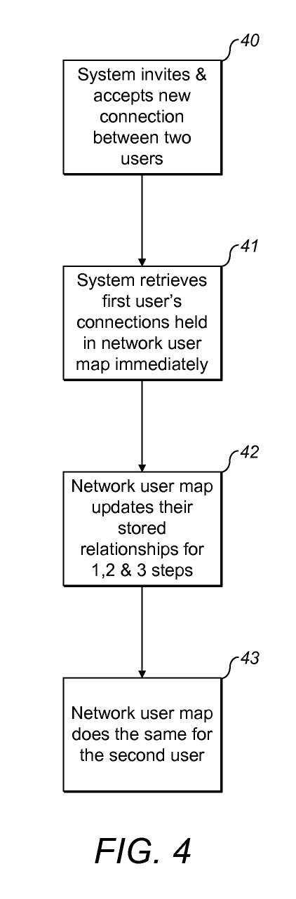

FIG. 3a shows the creation of the network user map for an exemplary user.

The relationships table of the database 14 permanently stores all the user connection information and comprises a row for each user connection (step 30 and FIG. 3b). Upon request by the application module 12, typically at start-up, a network file is created from the table, translating the rows of the database table into an array per user of their direct, primary or 1-step connections (step 31 and FIG. 3c).

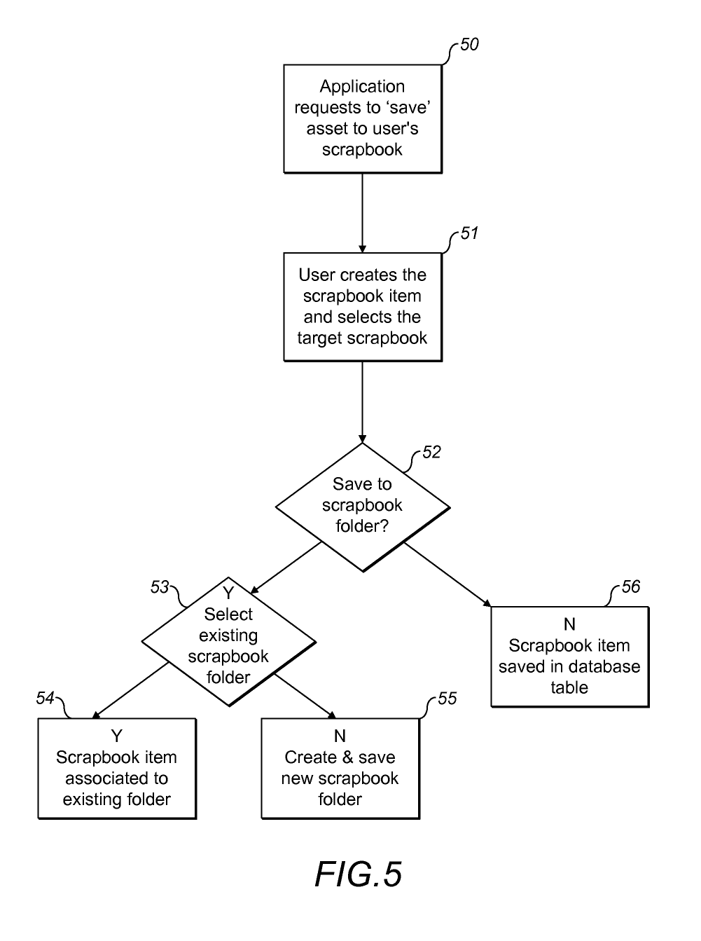

A network user map 13 is derived from the network file, by parsing the network file to identify all users within three (in this example) degrees of separation (step 32 and FIG. 3d). The network user map 13 is created by de-duping the shared connections between the two 1-step connections of the first user. Finally, the first user is removed from the resulting map to derive a map of all the users connected to the first user. The software used to create the network user map 13 is implemented using the ‘C’ programming language. The network user map 13 is stored in volatile memory (step 33), and is retrieved by the search engine 15 for each search, based on the identity of each searching user. The application module 12 enables a user to find other users in the network and invite them to make a connection with them. When an invitation is sent, a new row is created in the invitations table in the database. When the invitation is accepted, a new row is created in the relationships table in the database 14. This new connection made between two users, triggers the process shown in FIG. 4. The application module 12 updates any changes to both users' network connections in the network user map 13, to ensure both the network user map 13 and the database 14 are correct and up-to-date at all times (steps 40 to 43).

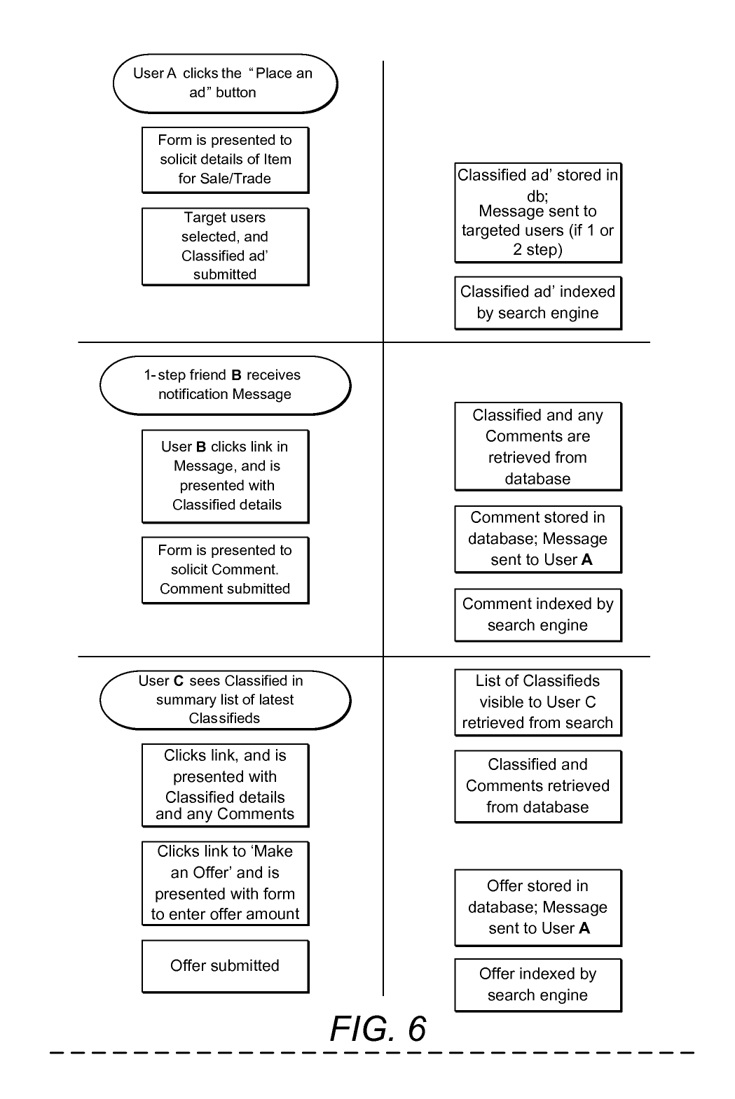

As shown in FIG. 5 and briefly discussed above, any content asset can be saved by a user into their personal or group scrapbook. This is then known as a scrapbook asset or item. The user can also create scrapbook folders to contain collections of scrapbook items into useful themes. A scrapbook item is an asset type with its own table in the database which comprises a title, text descriptor, creator and links to the content asset it ‘contains’. Creators of scrapbook items and folders can set permissions to determine their visibility subject to other users' degree of separation from the creating user. The same ‘collapsing’ functions apply to scrapbook items and scrapbook folders as all other content assets.

The user first requests to ‘save’ a content asset as a scrapbook item in their scrapbook (steps 50 and 51). The user is then given options to define the scrapbook item descriptors and visibility permissions. The application module 12 then creates a new scrapbook item in the scrapbook item table in the database 14. The application module 12 then provides the user with the option to store the scrapbook item within a scrapbook folder (step 52). If the user does not, it is stored in the database 14 (step 56). If the user wants to store the scrapbook item in a scrapbook folder they are given the option to create a new scrapbook folder or store in an existing scrapbook folder (step 53). The scrapbook item is then associated with an existing folder entry in the scrapbook folder table within the database 14 (step 54) or a new scrapbook folder entry is created in the database 14 and the scrapbook item associated with it (step 55).

As with all other content assets, scrapbook items and scrapbook folders are indexed by the search engine and can be searched for, ‘scrapbooked’ or shared between users in dependence on a viewing users network associations.

### Example

### Classified Advertisements

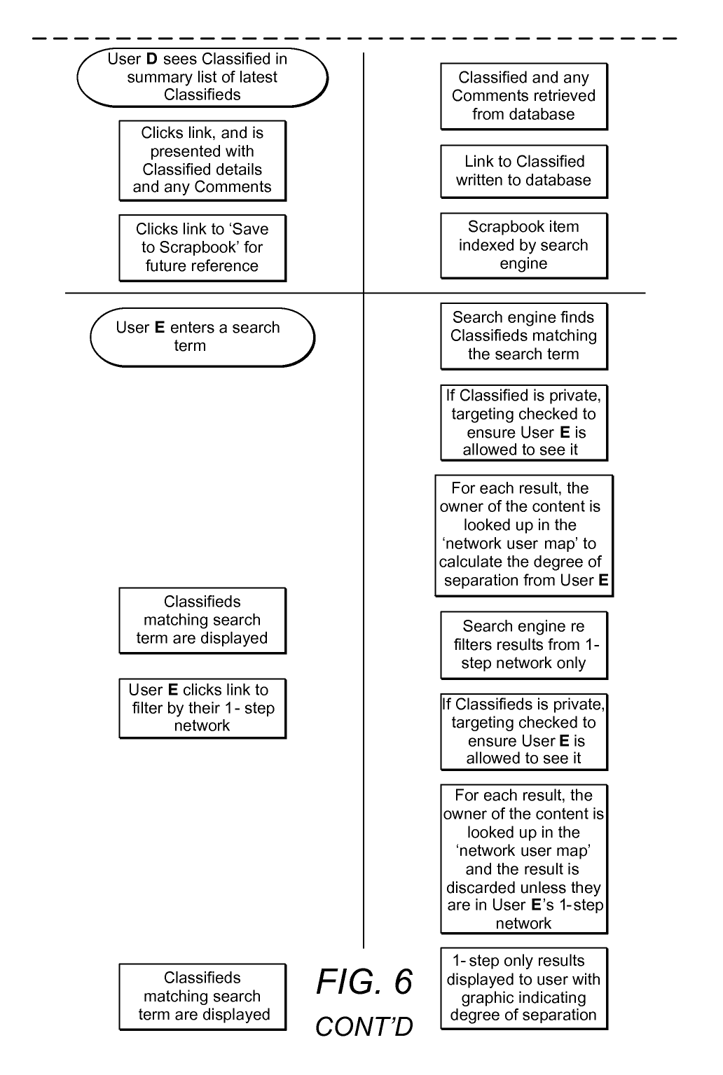

This example is described with reference to FIG. 6. In this sequence, the system is used by a specific user to either a) list a product or service for sale, to swap or give away; or b) to seek a product or service to buy, swap or source for free.

When the system is used by a user to make a product or service available for sale, to swap or give away to others, the user is prompted to select which group of people they would like to be able to see the specific product or service.

The default selection is everyone who is registered with the system, including but not limited to those people the user is either directly or indirectly connected with, that is everyone who is either a 1-step, 2-step connection and so on.

Assuming the user chooses to offer the product or service to everyone registered on the system, the sequence of actions is as follows:

The system adds the user's listing to the database of products and services available, and indexes it.

Once indexed, that product or service will be included and presented within the results when it meets the selection criteria of any selections made by other users.

It will also be presented by default to all users on the home page by recency, subject to viewing permissions.

The user's specific product or service will be made visible to all users who that user selects for that question to be visible to. Also, all categories of user who the specific user selects to be made aware of their specific product or service listing will be subsequently made aware of it via system and email alerts.

The specific product or service will be presented in the results when other users use the system's search functionality to search or browse for a product or service that matches the user's specific product or service.

When the system is used by a user to seek a product or service, the user is prompted to select which group of people they would like to see results from. The default selection is everyone registered with the present invention including but not limited to those people they are directly or indirectly connected with, that is everyone who is either a 1-step, 2-step connection and so on.

The system matches the user's query against the index of classified content assets already indexed from the universe that the user has selected that best match that individual user's question. Again, the user can filter results by the degrees of connectedness between themselves and the user offering the item.

Each product or service indexed will have a named creator user.

All classified content assets are displayed with the named creator's identity attached. The order of presentation (i.e. the ranking) is based on a number of criteria including the degrees of separation between the user and the source of each product or service.

A key feature of the site is the ability to filter these products or services available by the degrees of separation between the specific user requesting the information and the named source of the specific result.

If the contact network specific to the individual user changes (i.e. if the user adds or deletes a 1-step contact, or if someone who is a one step connection to them adds to deletes a 1-step contact, and so on) then for any search query that is requested subsequent to that user's contact network being updated, results will be filtered by that user's most up to date contact network. Users can dynamically expand or decrease their filter criteria by varying the degrees of separation used when searching. They may also apply other filter criteria such as geographical location.

### Step 1 User A Posting a New Classified Advert

Upon clicking the link to post a new Classified, User A is presented with a form to complete with a short description, full description, desired price of item, category (to allow browsing of Classifieds by similar objects/services) and an expiry date (after which Comments and Offers will not be accepted). The user can upload a photo to aid description/visualisation or upload a document to provide more detailed information.

The user then selects which group of people they would like to notify about the new Classifieds listing, choosing from all their 1-step friends, an ad-hoc selection of their 1-step friends, their 1 and 2-step friends combined, or groups they are a member of.

The final option on the form is to limit the visibility of the Classified to those selected in the notification stage, thus preventing users outside of this selection from seeing the Classified or any of its associated Comments.

Assuming the user chooses to make the classified advert available to everyone registered on the system, the sequence of actions is as follows:

The Classified details (descriptions and any attached assets or documents) are stored in the database and indexed by the search engine.

Notification Messages are sent to the users selected as the ‘target’ for this Classifieds listing. These messages are presented to each user in their ‘Message Inbox’ and via email provided by the system, and the message contains a link to go directly to the particular Classifieds listing.

The creator user can edit or close the classified at any stage.

### Step 2. User B Commenting on the Classified Listing

Clicking this link displays the Classified listing and any Comments to-date. User B can submit a Comment to the Classified advert from this screen; this Comment is then stored in the database and indexed by the search engine.

A Notification Message is sent to User A whenever a Comment is posted to their Classified. The commenting User B is automatically subscribed to subsequent alerts. User B can opt out at any time.

### Step 3. User C Making an Offer for the Classified Item

If User C is interested in making an offer for the item being advertised they can enter an amount, or details of another item they are offering to exchange, into a form. Additionally, they can accompany the offer with a private message containing conditions/caveats of offer etc.

The Offer details are then stored in the database and a Notification Message is sent to User A informing them of the Offer. User A and C can then agree collection/despatch details between themselves. The offer price without the user's identity is then displayed within the classified detail page.

Step 4. User D Saving the Classified Advert to their Scrapbook

The latest Classifieds submitted to the site are presented for the user to browse. They are also given the option to browse by Category.

In each of these cases, the results are obtained by performing a search for the latest Classified listings. The search engine checks to see that User D is allowed to see each document before including it in the result set, and it uses the NetworkMap to calculate the degree of separation between the Classified owner and User D so that a suitable graphic can be presented back to the user to signify the degree of separation.

Upon clicking one of the links, User D is presented with the Classified details in full, along with any Comments and offers to-date. Links are presented here to allow User D to reply with her own Comment or Offer, Save to her Scrapbook, or Share with a Friend.

Clicking “Save to Scrapbook” opens a form to allow the user to add a category and description, and the system then stores a link to the content in the user's account. This content is indexed by the search engine, and becomes another content asset that can be searched for and presented to other users.

“Share with a Friend” sends a link to the content in a Message to a selected friend or friends, allowing users to share discoveries and information.

Step 5. User E Searching for Information and being Presented with Results that they Subsequently Filter by their Network

When User E enters a search term into the ‘Search Classifieds’ input field on the site, the search engine first finds all matching Classifieds listings based on keyword-matching.

If any of the results found are marked as “Private” it then checks to see if User E is within the target permission network selected at the time the Classified was listed and discards the result if not.

For each of the results, the search engine then calculates the degree of separation between the Classified creator and User E, returning this to the Application along with the result summary.

If User E chooses to filter the results by their 1, 2 or 3-step network, the previous lookup is also used to control which results are included or discarded from the result set.

Two further filtering options are available to User E:
1) Geographical filtering—using geo-location technology to pinpoint User E with a location they specify, and comparing this to the location associated with the Classified advert.
   In this way, a filter can be applied to present only those Classifieds posted by users within a given radius of a point.
2) Groups—filtering the displayed Classifieds to show those posted by the members of a Group that User E is also a member of. Classifieds can also be posted “on behalf of” a Group by the Administrator of that Group, allowing a cricket club to sell their old practice nets, for example.

If User B is in User E′s 1-step network but User A is not, User E will then be presented with a collapsed comment asset detailing the comment made by User B. In this way, User E is able to view the comment and the original classified advert (if the permissions allow) even though User A, the original creator of the content asset, is not in User E′s 1, 2, or 3-step network.

It is important to note that while the present invention has been described in a context of a fully functioning data processing system, those of ordinary skill in the art will appreciate that the processes of the present invention are capable of being distributed in the form of a computer readable medium of instructions and a variety of forms and that the present invention applies equally regardless of a particular type of signal bearing media actually used to carry out distribution. Examples of computer readable media include recordable-type media such as floppy disks, a hard disk drive, RAM and CD-ROMs as well as transmission-type media such as digital and analogue communications links. The illustrated separation of components and functions into distinct units may reflect an actual physical grouping and allocation of such software and/or hardware, or can correspond to a conceptual allocation of different tasks performed by a single software program and/or hardware unit.

1. A computer implemented method of retrieving published content from a social network of users in which each user has connections to one or more other users, and in which the degree of separation between users within the social network is defined as the number of connections required to connect two given users, the method comprising the steps of:
storing a plurality of content assets published by users in a storage system, each content asset being indexed against one or more users in the network;
maintaining a network user map which, for each user, identifies degrees of separation between that user and other users in the social network;
receiving an online search request from a first user;
searching the stored content assets to identify one or more content assets that match the search request;
filtering the matching content assets to identify content assets indexed against users within the first user's network user map; and
generating search results for matching content assets which are ranked in dependence on the degree of separation between the first user and the user or users associated with the one or more matching content assets.

2. A method according to claim 1, wherein the network user map is dynamically updated when a new connection is created between a user and another user in the network.

3. A method according to claim 1, wherein the network user map is dynamically updated when an existing connection is deleted between a user and another user in the network.

4. A method according to claim 1, wherein the network user map is derived from a stored network file which has a list of all user connections with just one degree of separation.

5. A method according to claim 4, wherein the network user map is created by parsing the network file to identify all connecting users with n degrees of separation, where n is greater than or equal to two, and preferably n is equal to 3.

6. (canceled)

7. A method according to claim 1, wherein the search results indicate the degree of separation.

8. A method according to claim 1, wherein the search results identify the one or more users associated with the one or more matching content assets.

9. A method according to claim 1, wherein the one or more matching content assets are additionally ranked according to at least one other parameter.

10. A method according to claim 9, wherein the content assets are digital content selected from a group including: answers, attachments, categories, classifieds, comments, feedbacks, geocodes, groups, invitations, messages, offers, photo albums, questions, relationships, scrapbook folders, scrapbook items, subscriptions, users and weblinks.

11. (canceled)

12. A method according to claim 9, further comprising the step of determining whether the first user has permission to view the matching content asset.

13. (canceled)

14. A method according to claim 9, wherein content assets which are indexed are stored within polymorphic tables.

15. (canceled)

16. (canceled)

17. A computer system for retrieving published content from a social network of users in which each user has connections to one or more other users, and in which the degree of separation between users within the social network is defined as the number of connections required to connect two given users, the system comprising:
a database for storing a plurality of content assets published by users, each content asset being indexed against one or more users in the network;
a network user map stored in memory which, for each user, identifies degrees of separation between that user and other users in the social network;
an application interface for receiving an online search request from a first user;
a search engine having a system index for identifying one or more stored content assets that match the search request; and,
a processor for filtering the matching content assets to identify content assets indexed against users within the first user's network user map and generate search results ranked in dependence on the degree of separation between the first user and the user or users associated with the one or more matching content assets.

18. A system according to claim 17, in which the search engine of the system includes a web index thereby to facilitate searching of the world wide web (WWW) to identify web content that matches the search request.

19. A system according to claim 17, in which the content assets are digital content selected from a group including: answers, attachments, categories, classifieds, comments, feedbacks, geocodes, groups, invitations, messages, offers, photo albums, questions, relationships, scrapbook folders, scrapbook items, subscriptions, users and web links.

20. (canceled)

21. (canceled)

22. (canceled)

23. (canceled)

24. A system according to claim 17, in which content assets which are indexed by the search engine are stored within polymorphic tables within the database.

25. A non-transitory computer-readable medium storing program code, the program code executable by a computer to
store a plurality of content assets published by users in a storage system, each content asset being indexed against one or more users in the network;
maintain a network user map which, for each user, identifies degrees of separation between that user and other users in the social network;
receive an online search request from a first user;
search the stored content assets to identify one or more content assets that match the search request;
filter the matching content assets to identify content assets indexed against users within the first user's network user map; and
generate search results for matching content assets which are ranked in dependence on the degree of separation between the first user and the user or users associated with the one or more matching content assets.

26. A medium according to claim 25, the program code further executable by a computer to derive the network user map from a stored network file which has a list of all user connections with just one degree of separation.

27. A medium according to claim 26, the program code further executable by a computer to parse the network file to identify all connecting users with n degrees of separation, where n is greater than or equal to two, and preferably n is equal to 3.

28. A medium according to claim 25, the program code further executable by a computer to determine whether the first user has permission to view the matching content asset.

29. A medium according to claim 25, the program code further executable by a computer to store content assets which are indexed within polymorphic tables.
